(19) United States
(12) Patent Application Publication
(10) Pub. No.: US 2007/0031658 A1
(43) Pub. Date: Feb. 8, 2007

(54) Low opacity paper masking backing for pressure sensitive tapes

(76) Inventors: Timothy J. Rummel, Marysville, MI (US); John K. Tynan JR., Port Huron, MI (US)

Correspondence Address: THOMPSON HINE L.L.P., P.O. BOX 8801, DAYTON, OH, 45401-8801, US

(21) Appl. No.: 11/497,971

(22) Filed: Aug. 2, 2006

Related U.S. Application Data
(60) Provisional application No. 60/704,770, filed on Aug. 2, 2005.

(51) Int. Cl. B05D 5/00; B05D 1/18; B05D 1/00; B32B 7/12

(52) U.S. Cl. 428/343; 427/430.1; 427/209

(57) ABSTRACT

A tape which includes a substantially transparentized paper web and a substantially clear adhesive layer assembled into a tape, wherein the opacity of the tape is less than about 30%.

### CROSS-REFERENCE TO RELATED APPLICATIONS

This application claims the benefit of U.S. Provisional Application Ser. No. 60/704,770 filed on Aug. 2, 2005 which is incorporated herein by reference.

### BACKGROUND

This disclosure relates to pressure sensitive tapes, and more particularly to a low opacity paper masking backing for pressure sensitive tapes, and to the methods of producing the tapes. Paper in its most common form does not have good transparency without further treatment largely because of its fibrous nature and the consequent tendency for light to be scattered within it. It has been accepted that materials we describe as transparent have the ability to transmit parallel rays of light without scattering them seriously. So paper may be transparentized by treating it with a material which has an index of refraction equal to or close to that of the fiber of which it is composed. It becomes of interest to achieve transparency in paper by treating it with some material which does not detract from its end use requirements, which typically means filling the voids and interstices of the paper with a substance with an index of refraction approximately the same as that of paper.

Methods to transparentize paper and utilize opaque paper substrates as the backing for masking tape are well known in the art. Current masking tapes typically have an opacity greater than 40%. The opacity greater than 40% results in users not being able to see the adherent, preventing them from being able to position the tape ideally. Accordingly, there is a need for a low opacity paper masking backing for pressure sensitive tapes having an opacity of less than about 30%, thereby affording the user the ability to see the adherent to allow for exact positioning of the paper tape.

### SUMMARY

Tape useful in accordance with aspects of this invention is a transparentized, saturated masking tape which includes a transparentized, saturated paper web and a substantially clear adhesive layer assembled into a tape, wherein the opacity of the tape is less than about 30%.

The opacity as used herein is measured according to TAPPI T425 “Opacity of paper”.

Tape produced in accordance with some embodiments of the invention may exhibit one or more of the following characteristics:

MD (machine direction) Tensile of about 2 to about 16 kg/15 mm (about 8 to about 60 lbs/inch);

CD (cross-machine direction) Tensile of about 1 to about 8 kg/15 mm;

MD Elongation of about 1 to about 20%;

Caliper of about 25 to about 254 microns (about 1.0 to about 10.0 mils);

MD Finch Edge Tear of about 1 to about 15 kg (i.e., measures initiation of tear); and

CD Elmendorf Tear of greater than about 10 grams (i.e., measures propagation of tear).

### DETAILED DESCRIPTION

A combination of saturation process (e.g. sprayed, brushed, flexographic coated, blade coated, rod coated, gravure roll coated or immersed), saturant type (e.g. solution, dispersion, 100% solids or emulsion), saturant refractive index (i.e. close to or about matching that of cellulose, e.g., about 1.54), and minimization of void volume in the saturated sheet provides the translucent qualities described above for the backing.

Current paper masking tapes typically have an opacity greater than 40%. The opacity greater than 40% results in users not being able to see the adherent, making it difficult for them to position the tape ideally.

In one sense, the backing bridges the gap between the dispensability and handling characteristics of a traditional creped paper masking substrate and a thin, clear, film substrate. However, these clear, film backings do not typically demonstrate the same stress/strain characteristics of a traditional creped paper masking substrate, and are not hand tearable.

A transparentized, saturated paper may be manufactured by saturating a web with a saturant, allowing the saturant to remain in contact with the web for a period of time sufficient to saturate the web, and optionally removing the excess saturant. The application weight of the saturant is generally between about 60 and about 200 percent by weight based upon the dry weight of the paper substrate. The transparentized, saturated paper web may then coated with a substantially clear adhesive. In one embodiment, the adhesive coating layer thickness typically may be in the range of about 0.1 mil to 5.0 mil, and more typically in the range of about 0.5 mil to 3.0 mil. Below this range, the adhesive fails to produce sufficient tack. Above this range, the adhesive may transfer, cease to be removable, and/or be prohibitively expensive. Optionally, a release liner may be applied over the adhesive layer if the tape is to be wound into a roll. In another embodiment, the transparentized, saturated paper web may be coated with a release coating on the side opposite the adhesive coating.

In accordance with particular embodiments of the invention, the content of saturant in the fiber web may be from about 60 to about 200 parts by weight (dry solids) saturant to 100 parts by weight fiber web. The saturant can be any polymer emulsions, colloid dispersions, 100% solids polymers, solutions of polymers or mixtures thereof having a refractive index that approximately matches the fibrous web. In one embodiment, the saturant may have a refractive index in the range of about 1.3 to 1.8.

Transparency can be increased by minimizing void volume. One method to minimize the void volume involves removing the entrapped air which refracts light by the high levels of saturant used and removed. The void volume can be minimized by adding sufficient saturant to fill the void space in the paper.

Polymer emulsions characterized by a Tg (glass transition temperature) in the range of about −60 to +60° C., and a refractive index in the range of about 1.3 to 1.8 and capable of transparentizing the web are particularly useful saturants in accordance with certain embodiments of the invention. The preferred range of Tg is about −40 to 20° C., as below this range, the saturated paper will lack sufficient strength to perform as a masking tape, and above this range, the tape will be too stiff to properly conform to the adherent. The preferred range of refractive index is about 1.45 to 1.60, as outside this range, the opacity of the tape can be greater than about 30%.

Representative examples of rubber based emulsions and solutions are particularly useful saturants in accordance with certain embodiments of the invention include styrene butadiene rubber, nitrile rubber, neoprene rubber, butyral and butyl rubber, polysulfide rubber, silicone rubber, natural latex rubber and synthetic latex rubber. In a particular embodiment, reactive liquid nitrile rubber is used because it provides optimum clarity. In a more particular embodiment of the invention, the reactive liquid nitrile rubber is Hycar X31 available from Noveon.

Representative examples of resin-based emulsions are particularly useful saturants in accordance with certain embodiments of the invention include polyvinyl acetate, polyvinyl butyral, polyvinyl chloride, acrylic, alkyd, ethylene vinyl acetate, polyethylene-based, polyolefin based, nylon-based, phenol-based (including formaldehyde-based), urea based (including formaldehyde based), epoxy resin, polyurethane-based, rosin-based (including rosin esters), polyterpene-based, petroleum based, and low molecular weight based adhesives. In a particular embodiment, melamine formaldehyde resin is used because it crosslinks the nitrile moiety. In a more particular embodiment of the invention, the melamine formaldehyde resin is Cymel 303 available from Cytec.

Representative examples of 100% solids are particularly useful saturants in accordance with certain embodiments of the invention include LDPE (low-density polyethylene), HDPE (high-density polyethylene), other polyolefins, etc. For example, the 100% solid saturant may be extrusion laminated to the fibrous web substrate in a conventional manner.

In one embodiment, the saturant comprises about 1 to about 70 parts by weight of the reactive liquid nitrile rubber polymer, about 1 to about 30 parts by weight of the melamine formaldehyde resin, and about 67 to about 89 parts by weight toluene based upon the total weight of said transparentized medium composition.

The saturant may be applied by any means know to those skilled in the art. For example, the saturant may be sprayed, brushed, flexographic coated, blade coated, rod coated, gravure roll coated, or immersed without departing from the scope of this invention. In a more particular embodiment, blade coating is used to apply the saturant to the fibrous web because it optimizes the quantity of saturant retained in the fibrous web which minimizes the void volume by filling the void space in the paper.

In one embodiment, a dimensionally stable web of paper (known as flat back) which has low elongation, (e.g. about 1% to about 4%) which is typically useful for decal pre-mask applications which include masking for commercial vehicles and street graphics. NBSK (Northern Bleached Softwood Kraft) paper web is one suitable stock for use in this invention.

Another embodiment of the present invention calls for a web of paper (known as crepe) which has high elongation, (e.g. about 4% to about 55%) which is typically useful for masking applications. Creped NBSK (Northern Bleached Softwood Kraft) paper web is one suitable stock for use in this invention.

The following substantially clear adhesive compounds or solutions may be used, either alone or in combination, without departing from the scope of this invention.

Representative examples of rubber based adhesives useful in certain embodiments of the invention include styrene butadiene rubber, styrene-butadiene-styrene (SBS) rubber, styrene-isoprene-styrene (SIS) rubber, styrene-ethylene-butylene-styrene (SEBS) rubber, styrene-ethylene-propylene-styrene (SEPS) rubber, nitrile rubber, neoprene rubber, butyral and butyl rubber, polysulfide rubber, silicone rubber, natural latex rubber and synthetic latex rubber. In a more particular embodiment, styrene-isoprene-styrene (SIS) rubber based adhesive is used because it provides optimum clarity.

Resin-based adhesives such as, but not limited to, polyvinyl acetate, polyvinyl butyral, polyvinyl chloride, acrylic, ethylene vinyl acetate, polyethylene-based, polyolefin based, nylon-based, phenol-based (including formaldehyde-based), urea based (including formaldehyde based), epoxy resin, polyurethane-based, rosin-based (including rosin esters), polyterpene-based, polyester, petroleum based and low molecular weight based adhesives are within the scope of this invention.

Inorganic adhesives such as, but not limited to, silicate adhesive and wax adhesives such as, but not limited to, paraffin, natural wax, and bees wax are within the scope of this invention.

The saturants used in treating the papers may be selected to represent a range of refractive indices, and include, for example, tributoxyethyl phosphate, dioctyl phosphate, tributyl citrate, butyl stearate, tricresol phosphate, cresyl diphenyl phosphate, o-xenyl diphenyl phosphate, chloronaphthalene, alpha bromonaphthalene, and glycerin.

Transparentizing of Paper by Vaurio, F. 1960 TAPPI Journal Volume 43 Number 1 is incorporated herein by reference (See Appendix A). Table 1 and 2 provide a non-limiting list of various alternative saturants that may also be useful with this invention and the corresponding refractive index of the saturant. Table 3 and FIG. 1 also disclose saturants that may be suitable for use with this invention and the corresponding “transparency ratio” of the saturated paper.

The “transparency ratio” or the ratio of the parallel transmitted light to the total transmitted light may be used as the criterion for the degree of transparency. The relationship is believed to minimize the influence of color on the measurement of transparency. An Abbe’ refractometer and a sodium vapor light may be used to measure the index of refraction of the various saturants.

Embodiments of the invention may be employed in general purpose and premium paint masking and decal pre-mask applications. Pressure sensitive tapes produced in accordance with certain aspects of the invention provide superior paint masking properties, with the added advantage of affording the user the ability to see the adherend through the tape. These same translucent paper qualities also lend themselves to superior performance in decal pre-mask applications.

The following non-limiting examples enable certain aspects of the invention to be more clearly understood. A coarse creped NBSK (northern bleached softwood kraft) paper roll having a basis weight of 26 pounds per 3000 sq. ft. was coated with a transparentizing saturant at a dry weight of about 8 pounds to about 50 pounds per 3000 sq. ft. with a laboratory blade coating process using a chrome applicator roll 15 cm in diameter and rotating at 80 rpm. The paper roll sat in a bath of the saturant and its rotation applied the saturant to the paper at a line speed of about 4 meters per minute. The blade was positioned at a 60° angle to the web and removed excess saturant from the web before the web was dried to remove the toluene solvent and cure the resin. The transparentizing saturant was prepared by mixing Hycar X31 reactive nitrile rubber polymer and Cymel 303 melamine formaldehyde resin with a toluene solvent to 30% solids. The ratio of nitrile to melamine was 10 to 1 (dry weight basis). After cooling to room temperature, the opacity of the saturated paper web samples was measured according to TAPPI T425, and resulted in opacity measurements less than 30%.

Having described the invention in detail and by reference to specific embodiments thereof, it will be apparent that numerous variations and modifications are possible without departing from the spirit and scope of the invention as defined by the following claims.

What is claimed is:

1. A tape comprising a substantially transparentized paper web and a substantially clear adhesive layer assembled into a tape wherein the opacity of the tape is less than about 30%.

2. The tape of claim 1 wherein the adhesive layer comprises an adhesive, said adhesive is selected from the group consisting of rubber-based adhesives, resin-based adhesives, inorganic adhesives and blends thereof.

3. The tape of claim 2 wherein the adhesive layer comprises an styrene-isoprene-styrene based rubber pressure sensitive adhesive.

4. The tape of claim 1 wherein the composition of the transparentized paper web is about 60 to about 200 parts by weight (solids) of a transparentizing medium to 100 parts by weight dry paper web.

5. The tape of claim 4 wherein the refractive index of transparentizing medium is between about 1.3 and about 1.8.

6. The tape of claim 5 wherein the refractive index of transparentizing medium is between about 1.45 and about 1.60.

7. The tape of claim 4 wherein the transparentized medium has a glass transition temperature of about −60° C. to about 60° C.

8. The tape of claim 7 wherein the transparentized medium has a glass transition temperature of about −40° C. to about 20° C.

9. The tape of claim 4 wherein the transparentizing medium is selected from the group consisting of solution saturant, resin-based emulsion saturant, 100% solids saturant, rubber-based emulsion saturant and blends thereof.

10. The tape of claim 9 wherein the solution saturant is selected from the group consisting of tributoxyethyl phosphate, dioctyl phosphate, tributyl citrate, butyl stearate, tricresol phosphate, cresyl diphenyl phosphate, o-xenyl diphenyl phosphate, chloronaphthalene, alpha bromonaphthalene, glycerin and blends thereof.

11. The tape of claim 9 wherein the resin-based emulsion saturant is selected from the group consisting of polyvinyl acetate, polyvinyl butyral, polyvinyl chloride, acrylic, alkyd, ethylene vinyl acetate, polyethylene-based, polyolefin-based, nylon-based, phenol based (including formaldehyde-based), urea-based (including formaldehyde-based), epoxy resin, polyurethane-based, rosin-based (including rosin esters), polyterpene-based resin and blends thereof.

12. The tape of claim 9 wherein the rubber-based emulsion saturant is selected from the group consisting of styrene butadiene rubber, nitrile rubber, neoprene rubber, butyral rubber, butyl rubber, polysulfide rubber, silicone rubber, natural latex rubber, synthetic latex rubber and blends thereof.

13. The tape of claim 9 wherein the transparentized medium composition comprises about 10 to about 70 parts by weight of a reactive liquid nitrile rubber polymer, about 1 to about 30 parts by weight of a melamine formaldehyde resin, and about 67 to about 89 parts by weight toluene based upon the total weight of said transparentized medium composition.

14. A method for the preparation of a substantially transparent paper tape comprising the steps of:
saturating a paper web with a saturant that renders the web substantially transparent; and
coating the saturated paper web with a substantially clear adhesive on one side and a substantially clear release coating on the other side.

15. A tape comprising a paper web containing a saturant that renders the web substantially transparent and a substantially transparent adhesive layer, wherein the tape has an opacity less than about 30%.
